(19) United States
(12) Patent Application Publication
(10) Pub. No.: US 2015/0310037 A1
(43) Pub. Date: Oct. 29, 2015

(54) SYSTEM FOR COLLECTING, AGGREGATING AND INTERPRETING GEO-SPATIAL DATA FOR MARKETING AND SECURITY APPLICATIONS

(71) Applicants: Otman A. Basir, Waterloo (CA); Mossab O. Basir, Toronto (CA)

(72) Inventors: Otman A. Basir, Waterloo (CA); Mossab O. Basir, Toronto (CA)

(21) Appl. No.: 14/637,329

(22) Filed: Mar. 3, 2015

Related U.S. Application Data
(60) Provisional application No. 61/947,041, filed on Mar. 3, 2014.

(51) Int. Cl. G06F 17/30

(52) U.S. Cl. CPC G06F 17/30241; G06F 17/3087; G06F 17/30412

(57) ABSTRACT

The abounding dependence of people on mobile devices and ‘staying connected’ produces a valuable by-product for collection and interpretation of passive and dynamic location-based data from cellular networks, private and micro-networks as well as social platforms. Where traditional tools such as human-counters and/or static hardware deployments are used to determine traffic for a geographic region or point of interest, the disclosed describes a system that collects, aggregates and profiles bulk, geo-spatial mobility data from carrier networks, social media networks and distributed micro-networks (commercial centers, stadiums, etc.) for marketing and security applications.

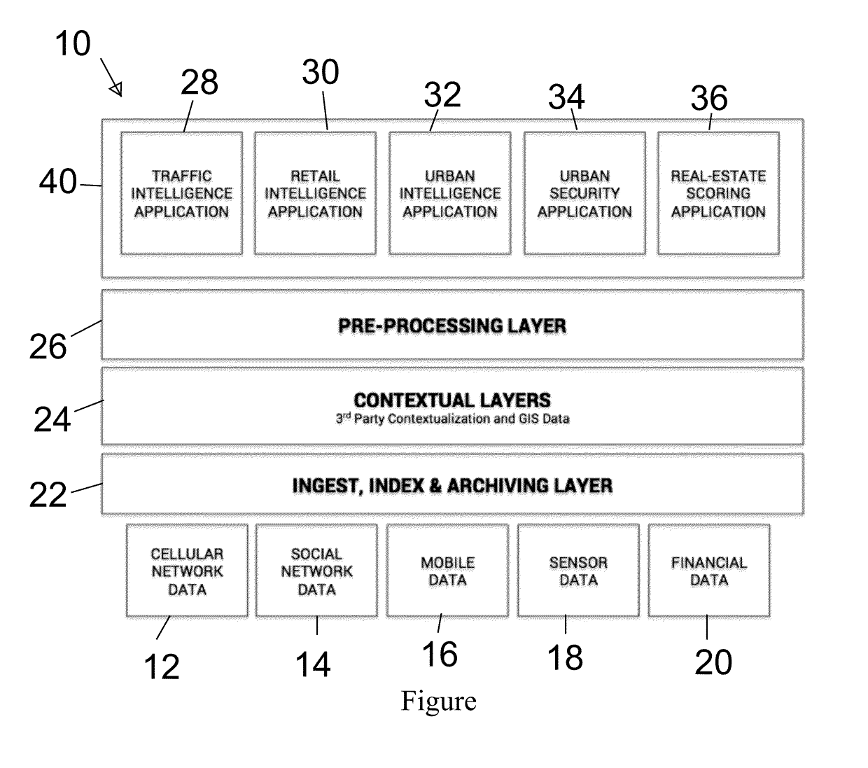

### BACKGROUND AND SUMMARY

The abounding dependence of people on mobile devices and ‘staying connected’ produces a valuable by-product for collection and interpretation of passive and dynamic location-based data from cellular networks, private and micro-networks as well as social platforms. Where traditional tools such as human-counters and/or static hardware deployments are used to determine traffic for a geographic region or point of interest, the disclosed describes a system that collects, aggregates and profiles bulk, geo-spatial mobility data from carrier networks, social media networks and distributed micro-networks (commercial centers, stadiums, etc.) for marketing and security applications.

### BRIEF DESCRIPTION OF THE DRAWINGS

The drawings can be briefly described as follows:

The FIGURE is a schematic of one possible implementation of the present invention.

### DETAILED DESCRIPTION

The FIGURE shows a system 10 according to one embodiment of the present invention. Data is collected from highly numerous sources, including cellular network data 12, social network data 14, mobile data 16, sensor data 18 and financial data 20. The data is first received from all these sources by an ingest, index and archiving layer 22. Contextual layers 24 access the ingested, indexed and archived data and provide 3^{rd} party contextualization and GIS data. This data is sent to the pre-processing layer 26.

The pre-processed data is accessed by a plurality of applications that provide different utility, as will be described below. For example, a server 40 (which may be a cluster of servers or multiple independent servers) may host a traffic intelligence application 28, a retail intelligence application 30, an urban intelligence application 32, an urban security application 34 and a real-estate scoring application 36.

The system 10 described herein collects and aggregates geo-spatial data from networks, social platforms and mobile applications and applies intelligent algorithmic analyses to this mobility data to derive meaningful information about a person, a cluster of persons or a geographic region.

The system 10 collects passive network data from an aggregate of unique mobile devices and mobile users.

The system 10 determines a unique identifier for each data-point using inherent attributes; for example using a subset of the IMEI of device, or MAC address, or IMSI, or TMSI, etc.

The system 10 interprets mobility data of persons through aggregating intermittent and frequent geo-spatial data from their mobile device over the course of a day, week, month, and years.

The system 10 interprets mobility data based on geographic indicators such as airports, parks, golf courses, art museums, etc. to derive behavioral attributes of each anonymous/non-anonymous user (ie: devices of persons on golf courses can mean the person is profiled as a ‘golfer’).

The system 10 overlays mobility data with other public and commercial databases to derive meaningful interpretations and profiles (ie: National census data, marketing databases, etc.)

The system 10 derives attributes for any defined cluster of persons using the aggregated mobility data.

The system 10 derives attributes for any defined single person using the aggregated mobility data (ie: home location, etc.)

The system 10 can ‘follow’ a prescribed database of individuals and/or clusters of persons for the purpose of:
Determining patterns and correlations
Extending and projecting trends
Historical forensic analysis
Broadcasting pre-programmed notifications related to the occurrence of a particular mobility and/or location event.

The system 10 derives attributes for a defined geographic region (within coverage) using the aggregated mobility data.

The system 10 profiles people, clusters of people and physically bound locations (neighborhoods, blocks, business locations, communities, buildings, etc.) for the purpose of determining insurance rates and premium-models.

The system 10 profiles people, clusters of people and physically bound locations (neighborhoods, blocks, businesses locations, communities, buildings, etc.) for the purpose of forecasting economic and financial trends.

The system 10 interprets mobility data for a user-defined point of interest (POI) (ie: a store, a stadium, a neighborhood, etc.)
The system 10 determines volume of mobility traffic for a POI for any given time period.
The system 10 determines frequency of mobility traffic for a POI (based on unique IDs) for any given time period.
The system 10 determines ‘traffic class’ of mobility data; for example walk-through, shopper, native, etc.
The system 10 determines ‘demographic profile’ of mobility data for a POI for any given time period.

The system 10 delivers aggregated data for consumption through a web-based portal:
The portal displays data for any geographic region (within coverage).
The portal displays data for user-defined areas (known as a geo-fence).
The portal displays data for user-defined filters (such as demographic, time of day, etc.).
The portal displays data for user-defined quantitative thresholds (foot traffic counts, repeat visits, peak visit times, low visit times, etc.).
The portal exports the data for further raw-data processing and/or custom reports.

A method for producing a real-time, persistent score for an asset (a store location, a neighbourhood/area, a roadway, a sports team, a stock, etc.) based on diverse data sources such as performance data, competitive intelligence, social network data, foot traffic, financial data, semantic data.

The score may also be affected by indirect data related to a ‘peer’ of the target asset. For instance, input that a nearby coffee shop is opening up within 1 km of another coffee shop.

A system 10 which exposes the affecting variables to the above described score using a interface for visualizing the score(s) and enabling the manipulation and management of these variables.

An example includes scoring a single Starbucks location (or a portfolio of locations) based on foot traffic data or data about new coffee shops opening within range of one or more locations.

What is claimed is:

1. A system comprising:
a server collecting and aggregating geo-spatial data from networks, social platforms and mobile applications and applying intelligent algorithmic analyses to this mobility data to derive meaningful information about a person, a cluster of persons or a geographic region.

2. The system of claim 1 wherein the server collects passive network data from an aggregate of unique mobile devices and mobile users.

3. The system of claim 1 wherein the server determines a unique identifier for each data-point using inherent attributes.

4. The system of claim 1 wherein the server interprets mobility data of persons through aggregating intermittent and frequent geo-spatial data from their mobile device over the course of a day, week, month, and years.

5. A method for collecting and analyzing data including the steps of:
collecting and aggregating geo-spatial data from networks, social platforms and mobile applications; and
applying algorithmic analyses to the geo-spatial data to derive meaningful information about a person, a cluster of persons or a geographic region.
